(19) United States
(12) Patent Application Publication
(10) Pub. No.: US 2007/0069893 A1
(43) Pub. Date: Mar. 29, 2007

(54) Polarization-based sensor for secure fiber optic network and other security applications

(75) Inventor: Duwayne Anderson, Saint Helens, OR (US)

Correspondence Address: VENABLE LLP, P.O. BOX 34385, WASHINGTON, DC, 20043-9998, US

(73) Assignee: CompuDyne Corporation

(21) Appl. No.: 11/366,817

(22) Filed: Mar. 3, 2006

Related U.S. Application Data
(60) Provisional application No. 60/658,369, filed on Mar. 4, 2005.

(51) Int. Cl. G08B 13/00

(52) U.S. Cl. 340/541

(57) ABSTRACT

A system, method, and computer program product for sensing an attempted intrusion including measuring changes in the state of polarization (SOP) of light transmitting through an optical fiber. The sensing system including a optical fiber in proximity to a secured element, and a fiber optic polarizer coupled to the optical fiber. The system may also include a transmitter, a receiver, and an electronic component for measuring changes in the state of polarization of the light transmitted through the optical fiber, wherein the light supplies information adequate to determine one or more polarization traces, an averaged trace based on the one or more polarization traces, and an intrusion trace.

### CROSS-REFERENCE TO RELATED APPLICATION

This application claims priority to U.S. Application No. 60/658,369 filed Mar. 4, 2005, the entire contents of which are hereby incorporated by reference.

### BACKGROUND OF THE INVENTION

1. Field of the Invention

This invention relates generally to security systems and more particularly to intrusion detection security systems.

2. Related Art

Individuals and institutions that send high-value data over secure networks want to be assured that their data is safe, and not subject to monitoring or tampering. The most secure manner of data transmission is over optical fibers because the fibers have no electromagnetic emissions. Still, optical fibers can be tapped, that is, monitored or tampered with. Such taps are considered intrusion events. They are often constructed by putting a slight bend into the fiber, which couples a small amount of optical power out of the fiber where it can be demodulated. One method of monitoring against such intrusions is to continuously measure the received optical power and activate the appropriate alarms if the power drops too much. This is problematic because optical taps require only small amounts of power, within the measurement noise/uncertainty of the power monitors.

Another approach is to secure the conduit, cable or other channel within which the optical fiber lays or is run. For example, the conduit might be constructed to be air tight, and then filled with pressurized gas (such as an inert gas). Intrusion is then detected by monitoring the gas pressure. Such methods are expensive and may not provide adequate or timely warnings.

Another conventional approach uses a modalmetric approach in which multimode fiber is placed in the conduit with the secure optical fiber. A speckle pattern results from the interference of the different modes in the fiber, and any disturbance of the optical fiber results in a measurable change in the mode pattern. This is an effective method of monitoring fibers in secure networks, but the operating range of the multimode sensors is limited due to attenuation within the multimode fibers, dispersion among the various modes, and the coherence length of the laser used in the sensor's light source. A further limitation is that the detectors place stringent requirements on the modal stability of the laser. Modalmetric sensors also waste a large percentage of the total transmitted optical power because they necessarily have limiting apertures that spatially limit the transmitted optical beam such that speckle fluctuations are transferred to received optical power fluctuations.

What is needed is a fiber-optic sensor that can detect any attempt at intrusion into the conduit carrying fibers without being restricted to short ranges. This sensor should also be useful for other applications that detect vibrations on fences, in structures, or in the ground, etc. The sensor should be simple, sensitive, inexpensive, and able to monitor in a distributed way many kilometers of optical fiber - especially single-mode optical fiber.

### SUMMARY OF THE INVENTION

An exemplary embodiment of the present invention sets forth a method of sensing an attempted intrusion that includes some or all of the operations of transmitting light of at least one known state of polarization within a first optical fiber, wherein the first optical fiber is in proximity to a secured element, and wherein the light originates from a polarized source; receiving the light at a fiber optic polarizer, wherein the fiber optic polarizer is in line with the first optical fiber; and identifying an attempted intrusion of the secured element from a change in the state of polarization of the light.

Another exemplary embodiment of the present invention sets forth a system for sensing an attempted intrusion comprising: a first optical fiber in proximity to a secured element; a transmitter, coupled to the first optical fiber, for sending polarized light of at least one known state of polarization through the first optical fiber; a fiber optic polarizer coupled to the first optical fiber; a receiver, coupled to the first optical fiber, for accepting the light within the first optical fiber; and an electronic component, coupled to the receiver, for measuring changes in the state of polarization of the light, wherein the light supplies information adequate to determine one or more polarization traces, an averaged trace based on the one or more polarization traces, and an intrusion trace.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1A depicts a diagram of an fiber optic sensor having a laser transmitter and a receiver, where the laser transmitter is coupled to an exemplary optical fiber, the optical fiber is coupled to a fiber optic polarizer, which itself is optionally coupled by optical fiber to the receiver, in an embodiment of the present invention;

FIG. 1B depicts an alternative embodiment of the fiber optic sensor of FIG. 1 A with additional components, according to an embodiment of the present invention;

FIG. 2 depicts an illustration of a polarization response from a shaking of the secure element in proximity of the fiber sensor, according to an embodiment of the present invention;

FIG. 3A depicts an illustration of an polarization response from a small tap on the secure element in proximity to the fiber sensor, according to an embodiment of the present invention;

FIG. 3B depicts an illustration of a polarization response from the small tap on the secure element in proximity to the fiber sensor, as shown in FIG. 3A, using a slightly different time scale, according to an embodiment of the present invention;

FIG. 4A depicts an illustration of a polarization response from a cutting of the secure element in proximity of the fiber sensor, according to an embodiment of the present invention;

FIG. 4B depicts an illustration of a polarization response from the cutting of the secure element in proximity of the fiber sensor, as shown in FIG. 4A, using a slightly different voltage scale, according to an embodiment of the present invention; and

FIGS. 5-7 depict flowcharts of the operations of the fiber sensor, according to embodiments of the present invention.

### DETAILED DESCRIPTION OF EXEMPLARY EMBODIMENTS OF THE PRESENT INVENTION

An exemplary embodiment of the present invention comprises a standard single-mode or multi-mode optical fiber in conjunction with a fiber optic polarizer. According to embodiments of the present invention, the fiber optic polarizer may be in-line with the optical fiber. Any disturbance of the optical fiber may result in a change in the fiber's optical birefringence, rotating the polarization vector and modulating the received optical power. In an exemplary embodiment of the present invention, fiber sensitivity may be roughly the same as a modalmetric sensor, but system sensitivity can be greater because the polarmetric approach does not require the use of limiting apertures, so more of the light may be available for measurement, which may increase the signal-to-noise ratio.

In one exemplary embodiment, implementation of the polarmetric sensor may be used with conventional modalmetric sensor units with little physical modification to the electronics. In another exemplary embodiment, the product may also require some adjustment of the thresholds used to detect an intruder. In an exemplary embodiment of the present invention, range may no longer be as limited by the laser, or its coherence length. The only limit on range, in an exemplary embodiment, may be the physical attenuation induced by the optical fiber, which can be made very low by using lasers that operate at, e.g., but not limited to, either 1310 nm or (for even lower loss) 1550 nm.

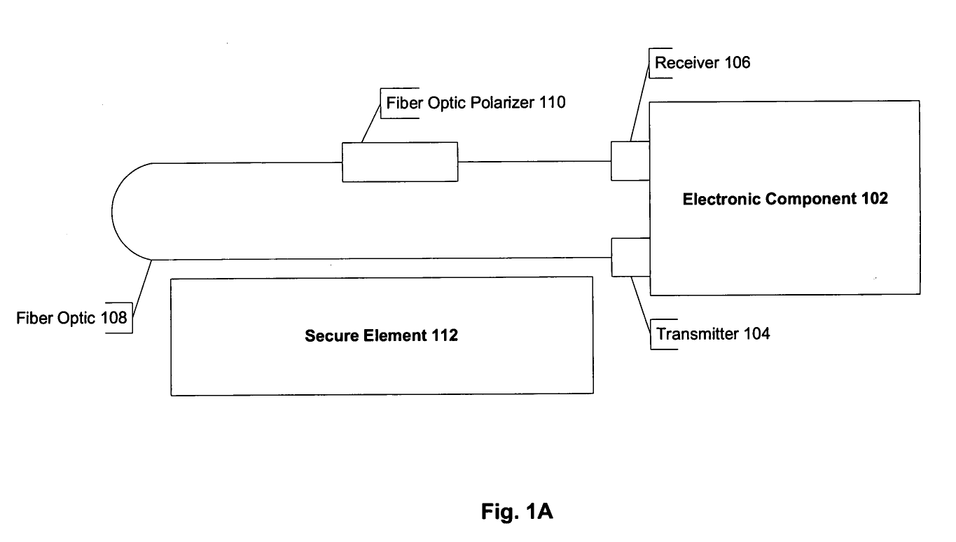

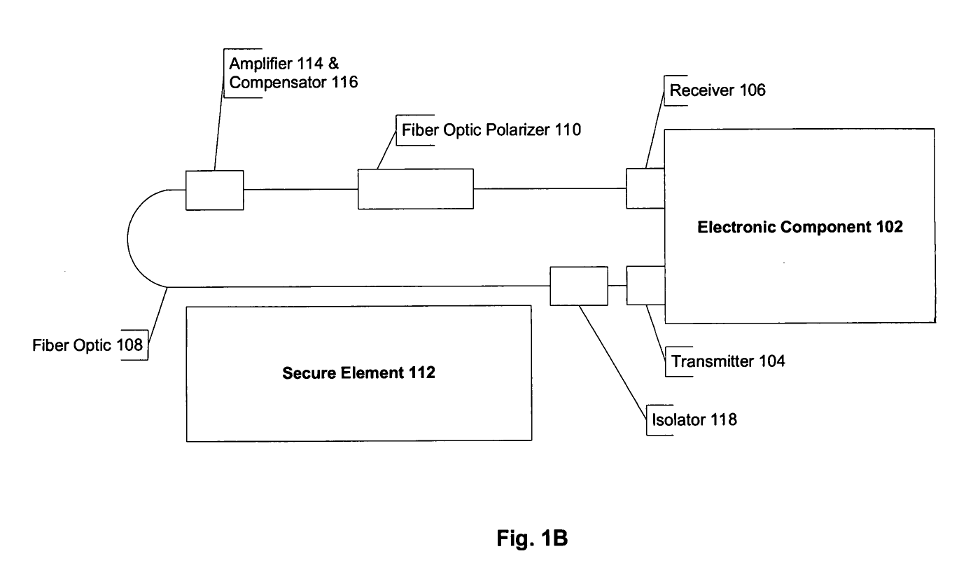

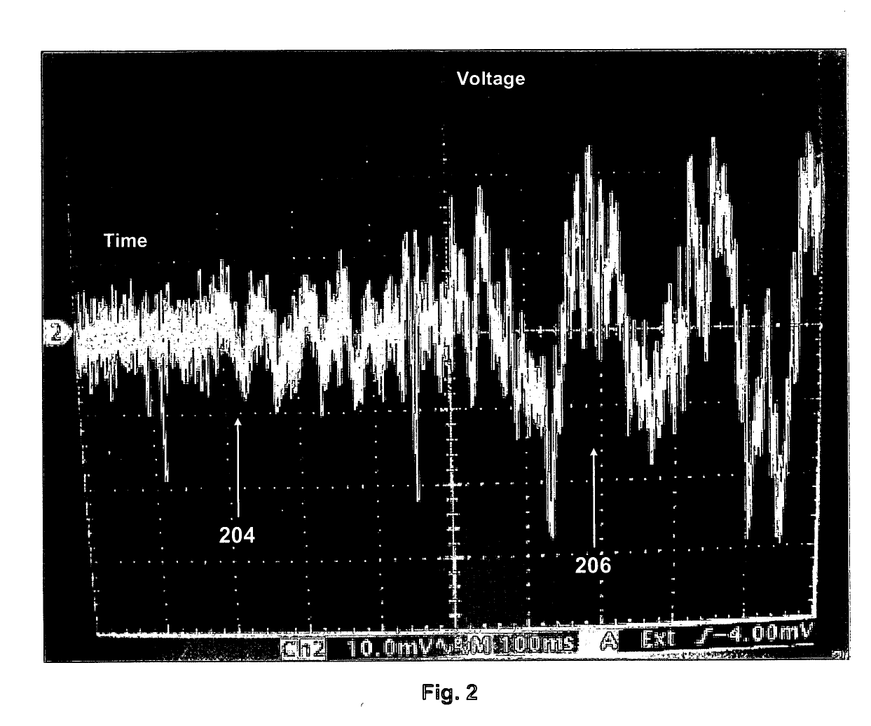

FIGS. 1A and 1B, described further below, illustrate exemplary embodiments of the invention. In these exemplary configurations, the invention may use conventional electronics component 102 (the Fiber Defender Model 208 (FD-208) fiber optic sensor, available from Fiber Sensys Inc., of Tualatin, OR USA) as part or most of electronic component 102, as well as additional components shown in the figures. In the depicted exemplary embodiment, a polarimetric sensor is shown configured for use with an exemplary opical fiber. FIGS. 2-4B, described further below, illustrate exemplary test data obtained using the configurations illustrated in FIGS. 1A-1B. Results show that the higher optical efficiency of an exemplary embodiment, allows the exemplary laser to be operated at a lower power level, which may reduce the laser noise and may increase the system's sensitivity.

FIG. 1A, specifically, depicts an exemplary diagram 100 of an electronic component 102, having a laser transmitter 104 and a receiver 106. In the exemplary embodiment, the laser transmitter 104 may be coupled to an exemplary optical fiber 108. According to embodiments of the present invention, the optical fiber 108 may b single mode or multi-mode. The optical fiber 108 may in turn be coupled to a fiber optic polarizer 110. According to embodiments of the present invention, the fiber optic polarizer 110 may be configured in-line with the optical fiber 108. Thus, an in-line polarizer 110, itself, may be coupled by optical fiber 108 to the receiver 106 of electronic component 102. In an exemplary embodiment of the present invention, the electronic component 102 may be a FIBER DEFENDER Model 208 (FD-208) fiber optic sensor, available from Fiber Sensys Inc., of Tualatin, OR USA. In an exemplary embodiment, the laser transmitter may be a Fabry-Perot (FP) or Distributed Feedback (DFB) or other polarized source.

In another embodiment of the present invention, a system for sensing an attempted intrusion, that is, a sensor, includes a first optical fiber 108 in proximity to a secured element 112. The first optical fiber 108 maybe a single mode fiber or a multi-mode fiber. In addition, the first optical fiber 108 may have been “dark fiber” within the same conduit or in proximity to the fiber 108 as the secured element 112, which may be one or more lit (in-use) optical fibers. The secured element 112 may be a second optical fiber within a channel, conduit, cable or other jacket. Thus, the secured area may encompass the physical parts of a fiber optic network, which may operate as a local area network (LAN), wide area network (WAN), one or more segments of a telecommunications or Internet backbone or other telecommunications network, such as, but not limited to, an intranet. The secured element 112 may also be installed in proximity to a fence or a structure, such as a building, enclosure, or other area or volume. In embodiments of the present invention, the secure element 112 may be contained within a duct or pipe or other container or channel, which is typical for installations.

According to embodiments of the present invention, an attempted intrusion includes, but it not limited to, an intruder tapping an optical fiber or tapping into or tampering with a channel that contains at least one optical fiber; an intruder cutting, climbing, or otherwise getting past a fence; or an intruder entering, moving, or otherwise trespassing at a structure. Therefore, an intrusion may include any form of tapping, tampering, trespassing, monitoring, or other unauthorized accessing.

Further, a transmitter 104 is coupled to the first optical fiber 108, for sending polarized light of at least one known state of polarization through the first optical fiber 108. A fiber optic polarizer 110, which may be coupled in-line to said first optical fiber 108, before a receiver 106. The polarizer 110 may provide the sensor with a higher efficiency and make it less susceptible to background noise. Furthermore, the fiber optic polarizer 110 may be a device having polarization dependent loss, a linear or non-linear polarizer, or a polarimeter. The receiver 106 accepts the light within the first optical fiber. The receiver 106 may include some form of photodiode and/or photomultiplier, as one of ordinary skill in the art would recognize based at least on the teachings provided herein.

Also part of the system is an electronic component 102, which may be coupled to the transmitter 104 and/or the receiver 106, for measuring changes in the state of polarization of the light, wherein the light supplies information adequate to determine one or more polarization traces, an averaged trace based on the one or more polarization traces, and an intrusion trace. It is noted, as one of ordinary skill in the art would appreciate, based at least on the teachings provided herein, that a “trace” is typically a measure of power fluctuation (with time) which would result from a transformation of the waveforms (voltage/time) illustrated in FIGS. 2, 3A-3B, and 4A-4B. According to the embodiments of the present invention, the term “trace” is used more broadly to include the pre-transform readings of voltage vs. time. As one of ordinary skill in the relevant art would appreciate, based at least on the teachings described herein, there is only one power trace and it is the received power as a function of time. The power changes with time when the state of polarization changes because the fiber optic polarizer lets through only one state of polarization.

In an alternative embodiment of the system of the present invention, the electronic component 102 records and analyzes one or more polarization traces when measuring changes to determine an intrusion trace.

According to embodiments of the present invention, as described above with respect to FIG. 1A, and below with respect to FIG. 1B, the polarized source may be a polarized laser or an unpolarized laser with a polarizer after the source, and prior to the first optical fiber.

In addition, more than one fiber optic polarizer may be employed by embodiments of the present invention. In one embodiment, a second fiber optic polarizer may be introduced, and the second polarizer may have a different phase than the first polarizer, such as by 45 degrees. This may compensate for polarization fading. Care should be taken, however, when introducing more than one fiber optic polarizer as a loss a sensitivity may result.

FIG. 1B depicts an alternative embodiment of the fiber optic sensor of FIG. 1A with additional components, according to an embodiment of the present invention. These components may not be required for the sensor system to perform as described herein, but they may provide specific advantages or features, which may be helpful to the detection of attempted intrusions.

According to such embodiments of the present invention, the system may further include an amplifier 114, such as, but not limited to, an optical amplifier, coupled to the first optical fiber after the transmitter, to strengthen the light in the first optical fiber. In an additional embodiment of the present invention, the system may further include a compensator 116, such as, but not limited to, a polarization mode dispersion compensator, coupled to the amplifier or directly to the first optical fiber, to counteract dispersion from the at least one known state of polarization of the light in the first optical fiber. In yet another embodiment, the system may include an isolator 118, such as, but not limited to, an optical isolator, coupled to the first optical fiber after the transmitter 104, to block reflections of the light from affecting the transmitter 104.

FIG. 2 depicts an illustration of a polarization response from a shaking of the secure element 112 in proximity of the fiber sensor, according to an embodiment of the present invention. In FIG. 2, the beginning of the shaking, in proximity to the first fiber optic 108, is indicated by arrow 204. The intrusion attempt grows in magnitude, as indicated by arrow 206. The system of the present invention, according to the embodiments described herein, provides senses capable of monitoring and reporting on such activities.

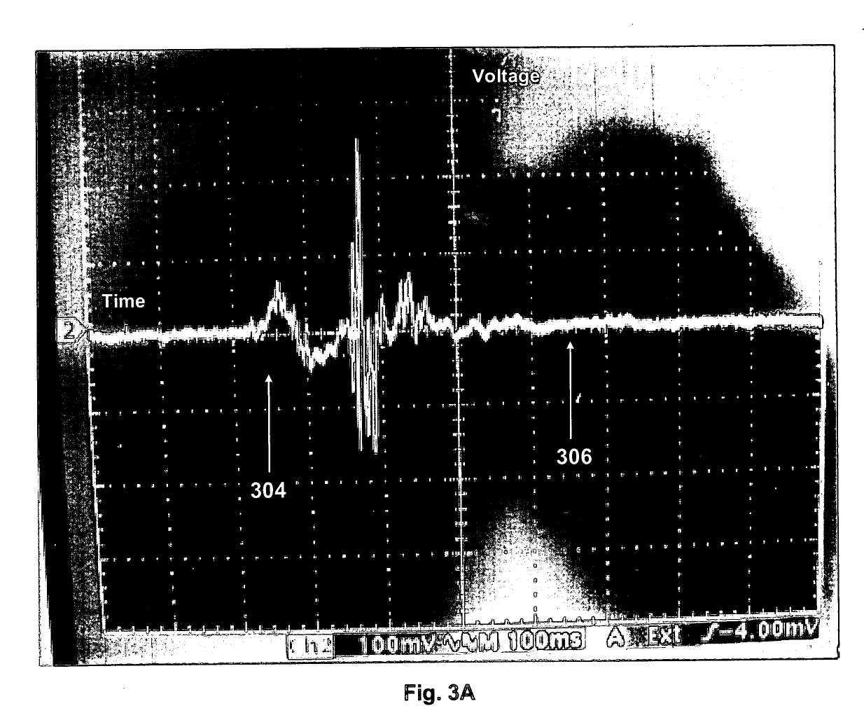

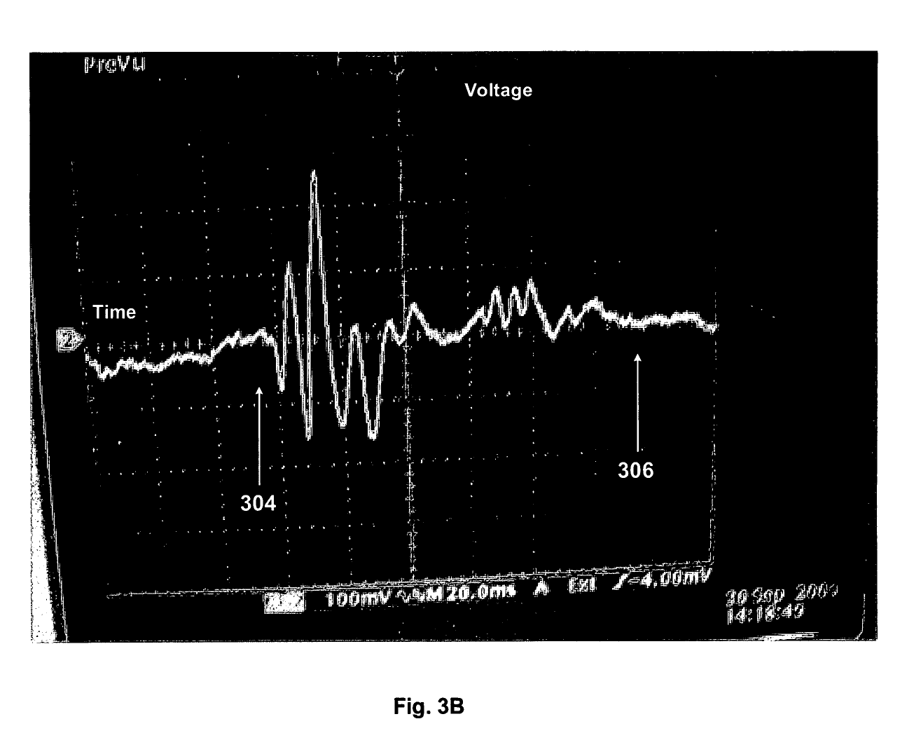

FIG. 3A depicts an illustration of a polarization response from a small tap on the secure element 112 in proximity to the fiber sensor, according to an embodiment of the present invention. In FIG. 3A, the tap can be seen in the area indicated by arrow 304. The resulting vibrations immediately follow, and the secured element 112 returns to a normal signal-to-noise level by arrow 306.

FIG. 3B depicts an illustration of a polarization response from the small tap on the secure element 112 in proximity to the fiber sensor, as shown in FIG. 3A, using a slightly different time scale, according to an embodiment of the present invention. Similarly, arrows 304 and 306 indicate the features described above.

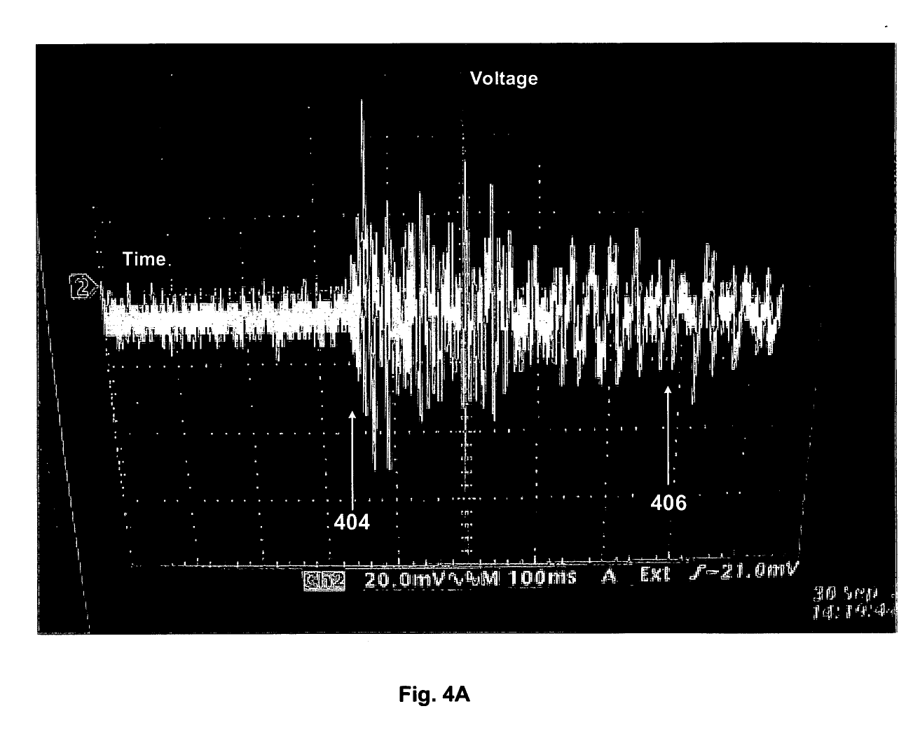

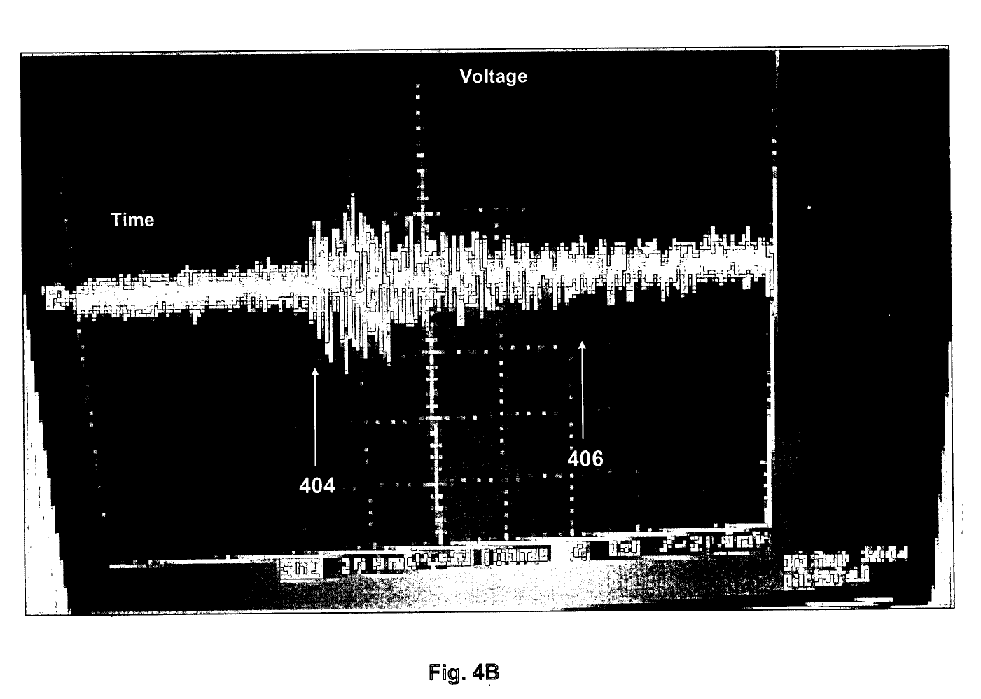

FIG. 4A depicts an illustration of a polarization response from a cutting of the secure element 112 in proximity of the fiber sensor, according to an embodiment of the present invention. In FIG. 4A, the start of the cutting is indicated by arrow 404. Prior to arrow 404, the signal is clear and steady. During the cutting, the signal has been altered considerable and provides a measurably different signal, as indicated by arrow 406.

FIG. 4B depicts an illustration of a polarization response from the cutting of the secure element 112 in proximity of the fiber sensor, as shown in FIG. 4A, using a slightly different voltage scale, according to an embodiment of the present invention, and using similar arrows 404 an 406 to indicate the signal levels before and during the intrusion attempt.

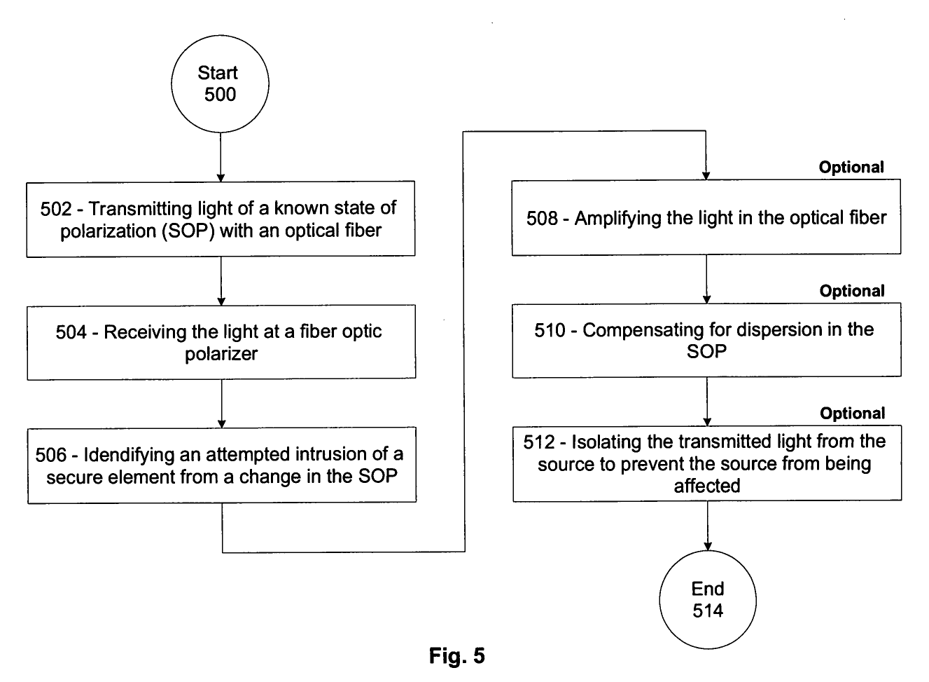

FIGS. 5-7 depict flowcharts of the operations of the fiber sensor, according to embodiments of the present invention.

The above-described sensor systems may, according to embodiments of the present invention, operate one or more methods of sensing an attempted intrusion including, as shown in FIG. 5, transmitting, at block 502, light of at least one known state of polarization within a first optical fiber 108, wherein the first optical fiber 108 is in proximity to a secured element 112, and wherein the light originates from a polarized source, such as transmitter 104; receiving, at block 504, the light at a fiber optic polarizer 110, wherein the fiber optic polarizer 110 is in-line with the first optical fiber 108; and identifying, at block 506, an attempted intrusion of the secured element 112 from a change in the state of polarization of the light.

According to alternative embodiments of the sensor system, the operations of the system may include, after said transmitting said light within said first optical fiber, amplifying, at block 508, the light in the first optical fiber; and compensating, at block 510, for dispersion from the at least one known state of polarization. Furthermore, the operations of the system may include isolating, at block 512, the polarized source of the light after the transmitting to block reflections of the light from affecting the polarized source.

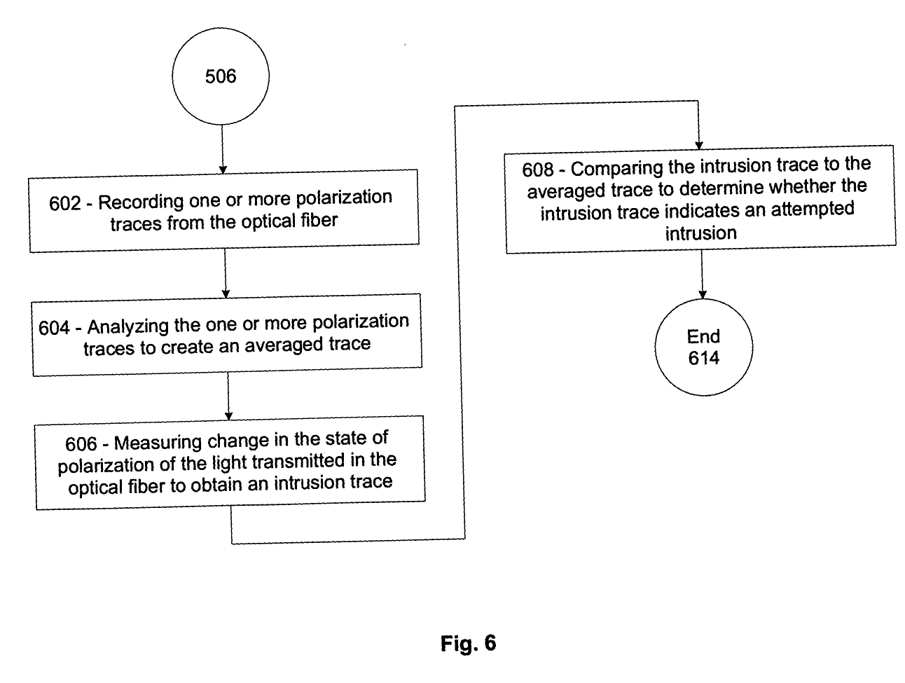

In another embodiment of the present invention, as shown in FIG. 6, the methods of operating of the sensor system may further include additional operations to the above-described identifying operation, at block 506. Block 506 may include recording, at block 602, one or more polarization traces from the first optical fiber; analyzing, at block 604, the one or more polarization traces to create an averaged trace; measuring, at block 606, changes in the state of polarization of the light transmitted through the first optical fiber to obtain an intrusion trace; and comparing, at block 608, the intrusion trace to the averaged trace to determine whether the intrusion trace is an attempted intrusion in proximity of the first optical fiber.

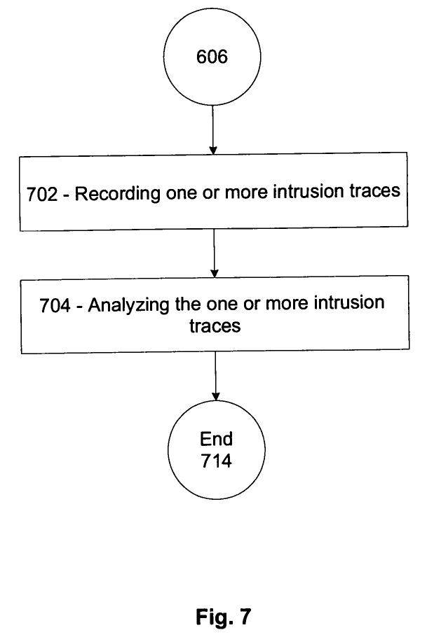

In another embodiment of the present invention, as shown in FIG. 7, the methods of operating of the sensor system may further include additional operations to the above-described measuring operation, at block 606. Block 606 may include recording, at block 702, one or more intrusion traces, and analyzing, at block 704, the one or more intrusion traces.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, that is, of a sensor system including at least the fiber optic and a fiber optic polarizer, it will be understood to those having ordinary skill in the art that changes in the above description or illustrations may be made with respect to formal detail without departing from the spirit and scope of the invention.

What is claimed is:

1. A method of sensing an attempted intrusion comprising:
transmitting light of at least one known state of polarization within a first optical fiber, wherein said first optical fiber is in proximity to a secured element, and wherein said light originates from a polarized source;
receiving said light at a fiber optic polarizer, wherein said fiber optic polarizer is in line with said first optical fiber; and
identifying an attempted intrusion of said secured element from a change in the state of polarization of said light.

2. The method of claim 1, wherein said identifying comprises:
recording one or more polarization traces from said first optical fiber;
analyzing said one or more polarization traces to create an averaged trace;
measuring changes in the state of polarization of said light transmitted through said first optical fiber to obtain an intrusion trace; and
comparing said intrusion trace to said averaged trace to determine whether said intrusion trace is an attempted intrusion in proximity of said first optical fiber.

3. The method of claim 2, wherein said measuring changes in the state of polarization of light includes (i) recording one or more intrusion traces, and (ii) analyzing said one or more intrusion traces.

4. The method of claim 1, wherein said fiber optic polarizer is either (i) a device having polarization dependent loss, (ii) a linear polarizer, (iii) a non-linear polarizer.

5. The method of claim 1, wherein said fiber optic polarizer is a polarimeter.

6. The method of claim 1, wherein said first optical fiber has a single mode.

7. The method of claim 1, wherein said first optical fiber has multiple modes.

8. The method of claim 7, further comprising:
after said transmitting said light within said first optical fiber,
(a) amplifying said light in said first optical fiber; and
(b) compensating for dispersion from said at least one known state of polarization.

9. The method of claim 1, further comprising:
isolating said polarized source of said light after said transmitting to block reflections of said light from affecting said polarized source.

10. The method of claim 1, wherein said secured element is at least a second optical fiber within a channel in proximity to said first optical fiber.

11. The method of claim 1, wherein said secured element is installed in proximity to a fence.

12. The method of claim 1, wherein said secured element is installed proximity to a structure.

13. The method of claim 1, wherein said attempted intrusion includes at least one of (i) an intruder tapping an optical fiber or tapping into a channel that contains at least one optical fiber, (ii) an intruder cutting, climbing, or otherwise getting past a fence, and (iii) an intruder entering, moving, or otherwise trespassing at a structure.

14. A system for sensing an attempted intrusion comprising:
a first optical fiber in proximity to a secured element;
a transmitter, coupled to said first optical fiber, for sending polarized light of at least one known state of polarization through said first optical fiber;
a fiber optic polarizer coupled to said first optical fiber;
a receiver, coupled to said first optical fiber, for accepting said light within said first optical fiber; and
an electronic component, coupled to said receiver, for measuring changes in the state of polarization of said light, wherein said light supplies information adequate to determine one or more polarization traces, an averaged trace based on said one or more polarization traces, and an intrusion trace.

15. The system of claim 14, wherein said electronic component records and analyzes one or more polarization traces when measuring changes to determine an intrusion trace.

16. The system of claim 14, wherein said transmitter includes at least one of a Fabry-Perot laser or a distributed feedback laser.

17. The system of claim 14, wherein said fiber optic polarizer is either (i) a device having polarization dependent loss, (ii) a linear polarizer, (iii) a non-linear polarizer, or (iv) a polarimeter.

18. The system of claim 14, wherein said first optical fiber has a single mode.

19. The system of claim 14, wherein said first optical fiber has multiple modes.

20. The system of claim 19, further comprising:
an amplifier, coupled to said first optical fiber after said transmitter, to strengthen said light in said first optical fiber; and
a compensator, coupled to said amplifier, to counteract dispersion from said at least one known state of polarization of said light in said first optical fiber.

21. The system of claim 14, further comprising:
an isolator, coupled to said first optical fiber after said transmitter, to block reflections of said light from affecting said transmitter.

22. The system of claim 14, wherein said secured element is at least a second optical fiber within a channel in proximity to said first optical fiber.

23. The system of claim 14, wherein said secured element is installed in proximity to a fence.

24. The system of claim 14, wherein said secured element is installed in proximity to a structure.

25. The system of claim 14, wherein said attempted intrusion includes at least one of (i) an intruder tapping an optical fiber or tapping into a channel that contains at least one optical fiber, (ii) an intruder cutting, climbing, or otherwise getting past a fence, and (iii) an intruder entering, moving, or otherwise trespassing at a structure.
